(19) United States
(12) Patent Application Publication
(10) Pub. No.: US 2013/0195580 A1
(43) Pub. Date: Aug. 1, 2013

(54) Fastening Means and Associated Production Method

(71) Applicants: Harald Kast, Waltenhofen (DE); Juergen Reiner, Gestratz (DE)

(72) Inventors: Harald Kast, Waltenhofen (DE); Juergen Reiner, Gestratz (DE)

(73) Assignee: Robert Bosch GmbH, Stuttgart (DE)

(21) Appl. No.: 13/581,959

(22) PCT Filed: Jan. 12, 2011
(86) PCT No.: PCT/EP2011/050293

§ 371 Date: Nov. 12, 2012

(30) Foreign Application Priority Data
Mar. 4, 2010 (DE) 10 2010 002 579.8

(51) Int. Cl. F16B 33/00

(52) U.S. Cl. CPC F16B 33/008
USPC 411/387.4; 428/615; 428/658; 428/650; 428/634; 428/646; 428/674; 205/170; 205/80; 427/402

(57) ABSTRACT

A fastening mechanism includes a basic body made from a base metal, onto which at least one corrosion-resistant layer is applied. A further layer is applied at least partially onto the at least one corrosion-resistant layer. The further layer has a lower coefficient of friction than the at least one corrosion-resistant layer.

### PRIOR ART

The invention is based on a fastening means in accordance with the preamble of independent patent claim 1 and on an associated production method in accordance with the preamble of independent patent claim 7.

Laid-open specification DE-A-2 322 352 describes a fastening means which is chromium-plated by electrodeposition, is made from carbon steel and has a screw thread. The fastening means described has good corrosion resistance properties and a structure of separate layers consisting of a structural base metal and a plurality of layers of metal or metal alloys, which are applied by electrolytic coating processes and provide good corrosion resistance properties and good adhesion properties.

### DISCLOSURE OF THE INVENTION

In contrast, the fastening means according to the invention having the features of independent patent claim 1 has the advantage that a further layer having a lower coefficient of friction than the at least one corrosion-resistant layer is applied at least partially to at least one corrosion-resistant layer.

According to the invention, a method for producing a fastening means having a main body which is made from a base metal and to which at least one corrosion-resistant layer is applied applies a further layer having a lower coefficient of friction than the at least one corrosion-resistant layer at least partially to the corrosion-resistant layer.

Embodiments of the present invention advantageously provide fastening means having a high corrosion resistance, these at the same time having good lubricating properties, or reduced coefficients of friction. The further layer can be applied to the corrosion-resistant layer directly or via at least one intermediate layer.

The core of the present invention consists in providing a suitable surface for a fastening means, which firstly has a positive effect on the coefficient of friction and secondly has no other negative effects on the screw connection partners or press-in partners used. In this respect, a further layer having a relatively low coefficient of friction is applied after the corrosion-resistant layer has been applied. The further layer, which is applied for example in the form of a termination layer, therefore takes over the lubricating properties and, depending on the material selected, can additionally also increase the corrosion resistance.

The measures and developments specified in the dependent claims make advantageous improvements to the fastening means specified in independent patent claim 1 and to the production method specified in independent patent claim 7 possible.

It is particularly advantageous that the corrosion-resistant layer is in the form of a zinc-nickel layer. Alternatively, the corrosion-resistant layer can be produced from an iron-zinc combination and/or from other materials or material combinations which are suitable for ensuring sufficient protection against corrosion. In this case, as materials which reduce the coefficient of friction for the further layer, it is possible to use zinc and/or aluminum and/or tin and/or copper and/or carbon and/or other materials or material combinations which are suitable for reducing the coefficient of friction. The use of zinc has the advantage that the technical devices and methods for applying the zinc layer are extensively available and known. Since the further layer is applied only for improving the coefficient of friction, this layer can be applied with a very small layer thickness in the range of approximately 1 to 15 μm, and thus advantageously does not have a substantial influence on the original form of the fastening means. In addition, stable and reduced coefficients of friction can be expected as a result of the very good bond between the zinc-nickel layer, as the corrosion-resistant layer, and the further zinc layer. The known chemical resistances, too, can be evaluated positively.

In an advantageous configuration of the fastening means, the main body comprises a thread, in particular a self-tapping thread. If the fastening means is in the form of a screw or bolt, it is possible, for example, for the further layer for reducing friction to be applied only to the thread region of the screw or to the shank region of the bolt. Alternatively, the further layer for reducing friction can be applied completely to the screw or the bolt.

In an advantageous configuration of the method according to the invention, the corrosion-resistant layer is applied to the base metal by an electrodeposition process and/or wet chemical process and/or spray process and/or dip process. Analogously, the further layer can be applied to the corrosion-resistant layer directly or via at least one intermediate layer by an electrodeposition process and/or wet chemical process and/or spray process and/or dip process.

In a further advantageous configuration of the method according to the invention, the further layer, in the form of a zinc layer, is applied to the corrosion-resistant layer directly or via at least one intermediate layer by a hot-dip galvanization process.

Embodiments of the invention can be used, for example, for the screwed connection of control units in a motor vehicle.

An exemplary embodiment of the invention is shown in the drawings and is explained in more detail in the description which follows.

### BRIEF DESCRIPTION OF THE DRAWING

FIG. 1 is a schematic sectional illustration of a detail of an exemplary embodiment of a fastening means according to the invention.

### EMBODIMENTS OF THE INVENTION

Metal sheets and metal parts, which are produced for example from steel and aluminum, are often provided with a coating which protects the sheet metal or part against attacks by corrosive media. By virtue of this coating, the adhesion of coats applied thereto can also be improved, which further improves the corrosion resistance of the sheet metal or part. However, some anti-corrosion coatings have Cr(VI)-containing compositions, which, on account of the toxic nature of Cr(VI), are no longer desirable. Within the framework of the EU End of Life Vehicles Directive and also the Electrical Scrap Directive, Cr(VI)-containing coatings are displaced, and therefore the need for alternative anti-corrosion coatings for metal parts in the automotive sector has risen steeply. Primarily in the field of connection technology with very high demands in terms of a small layer thickness in conjunction with a high corrosion resistance, there is still currently not a great choice of suitable coatings. Here, use is primarily made of thick layer passivations, topcoats and seals, which are used primarily on zinc layers. These alternative surfaces can have a negative effect on the screw connection conditions, for example the settling behavior, or can cause problems as a result of media incompatibility or functionally critical particle formation. In addition, in the case of screwed connections the coefficient of friction is almost always increased by one of said treatments.

In the prior art, the coating is formed with a zinc-nickel surface with regard to a high corrosion resistance. This is used with a rising trend particularly in the screw region in the case of high demands. The disadvantage of this coating lies in the structure of the layer on the surface. This layer has a friction-increasing action, and as a result the parameters change, e.g. in screw connection conditions, right up to the maximum permissible torque being exceeded. Particularly in the case of self-tapping screws, this limit is exceeded quickly in the case of screws coated with zinc-nickel. Other processes, e.g. press-in processes, are also adversely affected. In some cases, an attempt is made to solve this problem by means of additional friction-reducing topcoats. However, these usually do not suffice for eliminating the existing problems.

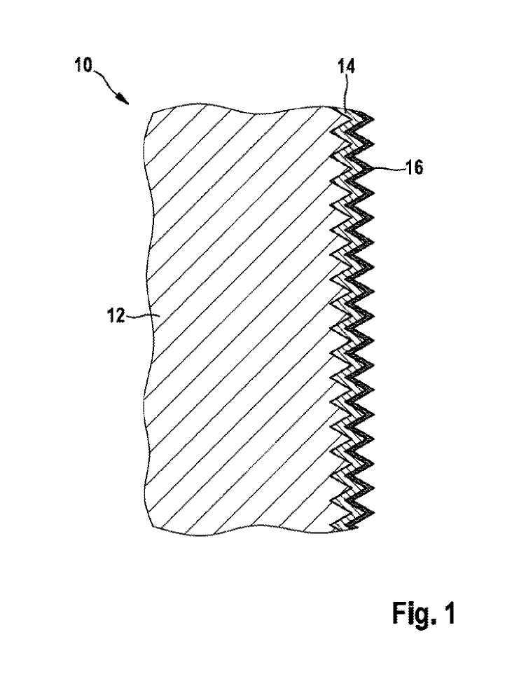

As can be seen from FIG. 1, the shown exemplary embodiment of a fastening means 10 according to the invention comprises a main body 12 which is made from a base metal and to which at least one corrosion-resistant layer 14, for example in the form of a zinc-nickel layer and/or iron-zinc layer, is applied.

According to the invention, a further layer 16 having a lower coefficient of friction than the at least one corrosion-resistant layer 14 is applied at least partially to the at least one corrosion-resistant layer 14. In the exemplary embodiment shown, the further layer 16 is in the form of a termination layer and is applied directly to the corrosion-resistant layer 14. Alternatively, further intermediate layers can also be arranged between the corrosion-resistant layer 14 and the further layer 16. In addition, a termination layer, for example a coating layer, can also be applied over the further layer 16. By way of example, the further layer 16 can be in the form of a zinc layer and/or aluminum layer and/or tin layer and/or copper layer and/or carbon layer, and has a thickness in a range of approximately 1 to 15 μm. For use in a motor vehicle, the main body 12 comprises a self-tapping thread, for example.

The further layer 16 according to the invention has a friction-reducing action, and therefore the screw connection conditions in the motor vehicle, in particular in the case of self-tapping screws having a corrosion-resistant zinc-nickel layer, can advantageously be improved, and exceedance of the maximum permissible torque can be prevented. In addition, other processes, for example press-in processes, are also positively influenced by the friction-reducing termination layer 16.

The method according to the invention for producing a fastening means 10 having a main body 12 which is made from a base metal applies at least one corrosion-resistant layer 14 to the main body. Then, according to the invention, a further layer 16 having a lower coefficient of friction than the at least one corrosion-resistant layer 14 is applied at least partially to the at least one corrosion-resistant layer 14. By way of example, the corrosion-resistant layer 14 can be applied to the base metal 12 by an electrodeposition process and/or a wet chemical process and/or a spray process and/or a dip process. The further layer 16, too, can be applied to the corrosion-resistant layer 14 directly or via at least one intermediate layer by an electrodeposition process and/or a wet chemical process and/or a spray process and/or a dip process. The further layer 16, in the form of a zinc layer, can be applied to the corrosion-resistant layer 14 directly or via at least one intermediate layer by a hot-dip galvanization process.

The significant advantage of the present invention consists in the fact that provision is made of fastening means having a high corrosion resistance, these at the same time having good lubricating properties, or reduced coefficients of friction.

1. A fastening mechanism comprising:
a main body made from a base metal;
at least one corrosion-resistant layer applied to the main body; and
a further layer having a lower coefficient of friction than the at least one corrosion-resistant layer applied at least partially to the at least one corrosion-resistant layer.

2. The fastening mechanism of claim 1, wherein the further layer is applied to the at least one corrosion-resistant layer directly or via at least one intermediate layer.

3. The fastening mechanism of claim 1, wherein the at least one corrosion-resistant layer comprises at least one of a zinc-nickel layer and an iron-zinc layer.

4. The fastening mechanism of claim 1, wherein the further layer comprises at least one of a zinc layer, an aluminum layer, a tin layer, a copper layer, and a carbon layer.

5. The fastening mechanism of claim 1, wherein the further layer has a thickness in a range of approximately 1 to 15 μm.

6. The fastening mechanism of claim 1, wherein the main body includes a self-tapping thread.

7. A method for producing a fastening mechanism comprising:
applying at least one corrosion-resistant layer to a main body that is made from a base metal; and
applying a further layer to the at least one corrosion-resistant layer, the further layer having a lower coefficient of friction than the at least one corrosion-resistant layer.

8. The method of claim 7, wherein the at least one corrosion-resistant layer is applied to the base metal by at least one of an electrodeposition process, a wet chemical process, a spray process, and a dip process.

9. The method of claim 7, wherein:
the further layer is applied to the at least one corrosion-resistant layer directly or via at least one intermediate layer; and
the further layer is applied by at least one of an electrodeposition process, a wet chemical process, a spray process, and a dip process.

10. The method of claim 7, wherein:
the further layer is a zinc layer; and
the further layer is applied to the corrosion-resistant layer directly or via at least one intermediate layer by a hot-dip galvanization process.
